(19) United States
(12) Patent Application Publication
(10) Pub. No.: US 2013/0050623 A1
(43) Pub. Date: Feb. 28, 2013

(54) LIQUID CRYSTAL DISPLAY, METHOD OF MANUFACTURING LIQUID CRYSTAL DISPLAY, AND APPARATUS FOR MANUFACTURING LIQUID CRYSTAL DISPLAY

(71) Applicants: Mamoru Okamoto, Tokyo (JP); Toshimasa Eguchi, (US); Shigeyoshi Otsuki, (US); Shinya Yamaguchi, (US)

(72) Inventors: Mamoru Okamoto, Tokyo (JP); Toshimasa Eguchi, (US); Shigeyoshi Otsuki, (US); Shinya Yamaguchi, (US)

(21) Appl. No.: 13/580,865

(22) PCT Filed: Mar. 4, 2010
(86) PCT No.: PCT/JP2010/053516

§ 371 Date: Oct. 30, 2012

(30) Foreign Application Priority Data
Feb. 26, 2010 (JP) 2010-042420

(51) Int. Cl. G02F 1/1337; H01J 9/26

(52) U.S. Cl. 349/123; 445/25; 445/66

(57) ABSTRACT

It is possible to prevent a decrease in contrast due to external light reflection and to implement a small-size, thin apparatus.

The liquid crystal display is configured by interposing alignment films and liquid crystal between a first substrate and a second substrate and adhering the first and second substrates through a gap retaining member and a sealant, wherein the first substrate is a substrate where a light blocking layer, a coloration layer, and a common electrode layer are formed on a plastic film substrate, wherein the second substrate is a substrate where a glass substrate where an active device is formed in advance adhered on a plastic film substrate, and wherein a barrier film is formed on one surface or two surfaces of at least one of the plastic film substrates.

### BACKGROUND OF THE INVENTION

1. Field of the Invention

The present invention relates to a liquid crystal display using a plastic film substrate, a method of manufacturing the liquid crystal display, and an apparatus for manufacturing the liquid crystal display.

2. Description of the Related Art

Recently, a liquid crystal display has been mounted on various mobile information apparatuses such as a mobile phone and a Personal Digital Assistant (PDA). In the mobile information apparatuses, since power consumption needs to be suppressed as much as possible, it is preferable that a reflective liquid crystal display or a semi-transmissive liquid crystal display using external light as much as possible be used as the liquid crystal display in order to suppress use of a backlight.

In such a liquid crystal display, liquid crystal is interposed between first and second substrates which are disposed to face each other, and facing surface sides of the first and second substrates where electrodes are installed are covered with respective alignment films. Due to the alignment films, alignment states of liquid crystal molecules included in the liquid crystal can be controlled. In addition, the first and second substrates are sealed with a sealant which is formed on the circumstances thereof, so that the liquid crystal is charged and sealed between the first and second substrates (refer to JP 2005-283693 A).

In addition, a pair of glass substrates is used as first and second substrates; liquid crystal is interposed between the pair of the glass substrates; and a voltage is applied to the liquid crystal by using an absorption-type polarizing plate disposed on the one glass substrate side of the liquid crystal, an reflection-type polarizing plate disposed on the other glass substrate side of the liquid crystal, and external light, so that a decrease in contrast due to external reflection is prevented (refer to JP 2008-185810 A).

Recently, according to requirement of a small-size, compact liquid crystal display, the liquid crystal display has been designed to be thin. In the case of implementing such a design, a pair of glass substrates are used as first and second substrates which are disposed to face each other, liquid crystal is interposed between the pair of the glass substrates; and a light blocking layer, a coloration layer, a common electrode layer, an active device, and the like are further formed on the substrate, so that there is a limitation in implementing a small-size, thin apparatus.

### SUMMARY OF THE INVENTION

The present invention is to provide a liquid crystal display capable of preventing a decrease in contrast due to external light reflection and being implemented as a small-size, thin apparatus, a method of manufacturing the liquid crystal display, and an apparatus for manufacturing the liquid crystal display.

In order to solve the aforementioned problems and achieve the objects, the present invention is configured as follows.

According to a first aspect of the present invention, there is provided a liquid crystal display configured by interposing alignment films and liquid crystal between first and second substrates and adhering the first and second substrates through a gap retaining member and a sealant, wherein the first substrate is a substrate where a light blocking layer, a coloration layer, and a common electrode layer are formed on a plastic film substrate, wherein the second substrate is a substrate where a glass substrate where an active device is formed in advance is adhered on a plastic film substrate, and wherein a barrier film is formed on one surface or two surfaces of at least one of the plastic film substrates.

A second aspect is the liquid crystal display according to the first aspect, wherein the alignment film is an optical alignment control type alignment film.

A third aspect is the liquid crystal display according to the first aspect, wherein the sealant is photo-curing sealant.

A fourth aspect is the liquid crystal display according to the first aspect, wherein the gap retaining member is a columnar spacer which is formed in a light blocking layer area of the first substrate side.

A fifth aspect is the liquid crystal display according to the first aspect, wherein the gap retaining member is a spherical spacer which is disposed between the first and second substrates and which is disposed in a light blocking layer area of the first substrate side.

A sixth aspect is the liquid crystal display according to the first aspect, wherein the first and second substrates have polarizing layers on surfaces that are different from an adhering surface.

A seventh aspect is the liquid crystal display according to the first aspect, wherein the second substrate is a substrate where active devices are directly formed on the plastic film substrate.

An eighth aspect is the liquid crystal display according to any one of the first to seventh aspects, wherein the active device of the second substrate has an active layer containing non-metallic elements as a mixture of oxygen (O) and nitrogen (N) having a ratio of N to O (N number density/O number density) from 0 to 2.

A ninth aspect is the liquid crystal display according to the first aspect, wherein the light blocking layer of the first substrate side is disposed above the active layer.

A tenth aspect is the liquid crystal display according to the ninth aspect, wherein the light blocking layer of the first substrate side is formed just on the active layer.

According to an eleventh aspect of the present invention, there is provided a method of manufacturing a liquid crystal display configured by interposing alignment films and liquid crystal between first and second substrates and adhering the first and second substrates through a gap retaining member and a sealant, including: forming the first substrate by forming a light blocking layer on a plastic film substrate, forming a coloration layer, and forming a common electrode layer; forming the second substrate by forming an active device on a glass substrate and adhering the glass substrate to the plastic film substrate; forming a barrier film on one surface or two surfaces of at least one of the plastic film substrates; forming alignment films on the adhering surfaces of the first and second substrates, respectively; and performing sealant delineation using an ODF process, charging liquid crystal, adhering through the delineated sealant, and curing the sealant.

A twelfth aspect is the method of manufacturing a liquid crystal display according to the eleventh aspect, wherein at least one of the plastic film substrate of the first substrate and the plastic film substrate of the second substrate has a rolled shape.

A thirteenth aspect is the method of manufacturing a liquid crystal display according to the eleventh aspect, wherein a columnar spacer which is disposed on a light blocking layer area of the first substrate side is formed as the gap retaining member by using a photolithography method.

A fourteenth aspect is the method of manufacturing a liquid crystal display according to the eleventh aspect, wherein a spherical spacer which is disposed between the first and second substrates and on a light blocking layer area of the first substrate side is formed as the gap retaining member by using a fixed-point arrangement method.

A fifteenth aspect is the method of manufacturing a liquid crystal display according to the eleventh aspect, wherein a polarizing layer is formed on a surface different from adhering surfaces of the first and second substrates by using an adhering method.

A sixteenth aspect is the method of manufacturing a liquid crystal display according to the eleventh aspect, wherein a polarizing layer is formed on a surface different from adhering surfaces of the first and second substrates by using a coating method.

A seventeenth aspect is the method of manufacturing a liquid crystal display according to the eleventh aspect, wherein the second substrate is manufactured by using a method of directly forming the active device on the plastic film substrate.

An eighteenth aspect is the method of manufacturing a liquid crystal display according to any one of the eleventh to seventeenth aspects, wherein, in the active device of the second substrate, an active layer containing non-metallic elements as a mixture of oxygen (O) and nitrogen (N) having a ratio of N to O (N number density/O number density) from 0 to 2 is formed by a sputtering method.

A nineteenth aspect is the method of manufacturing a liquid crystal display according to the eighteenth aspect, wherein the first and second substrates are adhered so that a light blocking layer of the first substrate side is disposed above the active layer.

A twentieth aspect is the method of manufacturing a liquid crystal display according to the eighteenth aspect, wherein a light blocking layer of the first substrate side is formed just on the active layer by using a photolithography method.

According to a twenty-first aspect of the present invention, there is provided an apparatus for manufacturing a liquid crystal display by performing the method of manufacturing a liquid crystal display according to any one of the eleventh to seventieth aspects.

According the above configurations of the present invention, the following effects can be obtained.

According a first aspect of the invention, the first substrate is a substrate where a light blocking layer, a coloration layer, and a common electrode layer are formed on a plastic film substrate; the second substrate is a substrate where a glass substrate where the active device is formed in advance is adhered on a plastic film substrate; and barrier film is formed on one surface or two surfaces of at least one of the plastic film substrates. Since the plastic film substrate are used for the first and second substrates, in comparison with a liquid crystal display using a glass substrate in the related art, the liquid crystal display becomes thinner and difficult to be broken.

According to the first aspect of the invention, the alignment films are optical alignment control type alignment films. Since a rubbing process is unnecessary, dust due to shaving of the alignment films is not generated, and electrostatic charges due to abrasion do not occur. In addition, since the optical alignment control is of a non-contact method, the alignment process can be uniformly performed on the entire surface without influence or unevenness of a base film.

According to the first aspect of the invention, the sealant is a photo-curing sealant. In comparison with a thermosetting sealant, the curing time can be reduced. In addition, since heat is not used for curing, expansion of the plastic film substrates which are base members can be suppressed, and the size of a to-be-cured liquid crystal display can be small.

According to the first aspect of the invention, the gap retaining member is a columnar spacer formed in the light blocking layer area of the first substrate side. Since the columnar spacer is formed only in the light blocking layer area of the first substrate, no spacer exists in the opening portion, and no disturbance of alignment occurs, so that contrast becomes high.

According to the first aspect of the invention, the gap retaining member is a spherical spacer which is disposed between the first and second substrates and formed in the light blocking layer area of the first substrate side. Since the spherical spacer is formed only in the light blocking layer area of the first substrate, no spacer exists in the opening portion, and no disturbance of alignment occurs, so that contrast becomes high. In addition, since the spherical spacer has larger elastic deformation and smaller plastic deformation than the columnar spacer, the liquid crystal display can smoothly respond to external pressure.

According to the first aspect of the invention, each of the first and second substrates has a polarizing layer on the surface different from the adhering surface, so that transmission of backlight beams passing through the liquid crystal display can be controlled.

According to the first aspect of the invention, the second substrate is a substrate where the active device is directly formed on the plastic film substrate. Since the active device is directly formed, the liquid crystal display becomes lighter and thinner and difficult to be broken.

According to the first aspect of the invention, since the active device of the second substrate includes an active layer containing non-metallic elements as a mixture of oxygen (O) and nitrogen (N) having a ratio of N to O (N number density/O number density) from 0 to 2 and is transparent with respect to visible light, transmittance of the display is increased, so that a backlight can have lower power consumption. In addition, since the substrate has flexibility, the display is flexible, and performance characteristics are improved.

According to the first aspect of the invention, a light blocking layer of the first substrate side is disposed above the active layer. Therefore, when external light is incident from the viewing direction to the display, the incident light does not hit the active layer, so that malfunction and change in characteristics are difficult to occur in the active layer.

According to the first aspect of the invention, the light blocking layer of the first substrate side is formed just on the active layer. Therefore, when the external light is incident from the viewing direction to the display, the incident light does not hit the active layer, so that malfunction and change in characteristics in the active layer can be suppressed. In addition, since the light blocking layer is disposed just on the active layer, internal scattered light of the backlight included in the display does not also hit the active layer, so that the change in characteristics are more difficult to occur.

According to a second aspect of the invention, the first substrate is manufactured by forming a light blocking layer, a coloration layer, and a common electrode layer on the plastic film substrate; the second substrate is manufactured by forming an active device on the glass substrate; the glass substrate is adhered on the plastic film substrate; and barrier films are formed on one surface or two surfaces of at least one of the plastic film substrates. Therefore, penetration of external impurities such as water vapor or a gas is suppressed, so that reliability of a liquid crystal display is improved. In addition, alignment films are formed on adhering surfaces of the first and second substrates; sealant delineation using an ODF process is performed; liquid crystal charging is performed; adhering is performed through the delineated sealant; the sealant curing is performed. Therefore, since the ODF process is used, a panel process using a roll-to-roll method can be implemented.

According to the second aspect of the invention, at least one of the plastic film substrate of the first substrate and the plastic film substrate of the second substrate has a rolled shape, so that a panel process using a roll-to-roll method can be implemented, and the manufactured display panel can be wound in a rolled shape.

According to the second aspect of the invention, the columnar spacer disposed on the light blocking layer area of the first substrate side is formed as the gap retaining member by using a photolithography method. Since the columnar spacer can be formed on the light blocking layer area of the first substrate side at high accuracy by the photolithography method, a line width of the light blocking layer can be reduced, so that transmittance of the liquid crystal display is improved.

According to the second aspect of the invention, the spherical spacer which is disposed between the first and second substrates and on the light blocking layer area of the first substrate side is formed as the gap retaining member by using a fixed-point arrangement method. Since the spherical spacer can be formed on the light blocking layer area of the first substrate side at high accuracy, a line width of the light blocking layer can be reduced, so that transmittance of the liquid crystal display is improved.

According to the second aspect of the invention, since the polarizing layers are formed on the surfaces different from the adhering surfaces of the first and second substrates by using an adhering method, a thinner liquid crystal display can be implemented.

According to the second aspect of the invention, since the polarizing layers are formed on the surfaces different from the adhering surfaces of the first and second substrates by using a coating method, a thinner liquid crystal display can be implemented.

According to the second aspect of the invention, the second substrate is manufactured by using a method of directly forming the active device on the plastic film substrate. Therefore, the liquid crystal display becomes thinner and lighter and difficult to be broken.

According to the second aspect of the invention, the active device of the second substrate including the active layer containing non-metallic elements as a mixture of oxygen (O) and nitrogen (N) having a ratio of N to O (N number density/O number density) from 0 to 2 is formed by using a sputtering method. Since the active device can be formed by using a sputtering method (room temperature) without using a plasma CVD method (300° C.) in the related art, a low-environmental-load, low-temperature process can be implemented.

According to the second aspect of the invention, the first and second substrates are adhered so that the light blocking layer of the first substrate side is disposed above the active layer. Therefore, when external light is incident from the viewing direction to the display, the incident light does not hit the active layer, so that malfunction and change in characteristics are difficult to occur in the active layer.

According to the second aspect of the invention, the light blocking layer of the first substrate side is formed just on the active layer by using a photolithography method. Since the light blocking layer can be formed at high accuracy, a line width of the light blocking layer can be reduced, so that transmittance of the liquid crystal display is improved.

According to a third aspect of the invention, the display is manufactured by performing the method of manufacturing the display according to the second aspect. Therefore, the liquid crystal display becomes lighter and thinner and difficult to be broken.

### BRIEF DESCRIPTION OF THE DRAWINGS

FIG. 1 is a schematic diagram illustrating a configuration of a liquid crystal display;

FIG. 2 is a schematic diagram illustrating a configuration of a plastic film substrate of a second substrate;

FIG. 3 is a schematic diagram illustrating a configuration of a liquid crystal display according to a second embodiment;

FIG. 4 is a schematic diagram illustrating a configuration of a liquid crystal display according to a third embodiment;

FIG. 5 is a schematic diagram illustrating a configuration of a liquid crystal display according to a fourth embodiment;

FIG. 6 is a schematic diagram illustrating a configuration of a liquid crystal display according to a fifth embodiment;

FIG. 7 is a schematic diagram illustrating a configuration of an apparatus for manufacturing a first substrate;

FIG. 8 is a schematic diagram illustrating a configuration of an apparatus for manufacturing a second substrate;

FIG. 9 is a schematic diagram illustrating a configuration of an apparatus for adhering first and second substrates;

FIG. 10 is a schematic diagram illustrating a sputter apparatus; and

FIG. 11 is a perspective diagram illustrating a plastic film substrate.

### DETAILED DESCRIPTION OF EMBODIMENTS

Hereinafter, a liquid crystal display, a method of manufacturing a liquid crystal display, and an apparatus for manufacturing a liquid crystal display according to embodiments of the present invention will be described. Although these embodiments are exemplary embodiments, the present invention is not limited thereto.

### Liquid Crystal Display

### First Embodiment

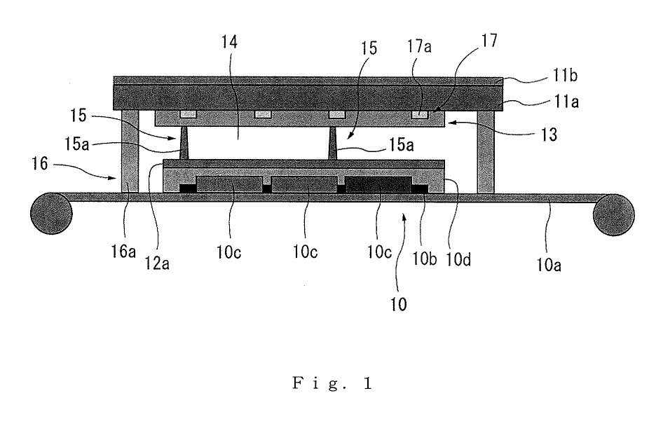

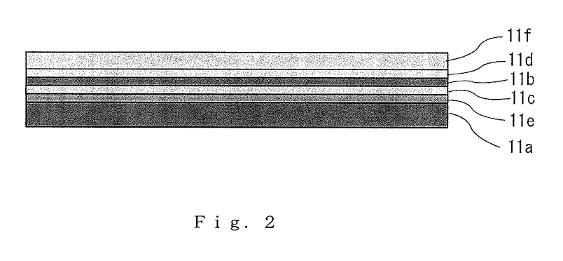

The liquid crystal display according to a first embodiment will be described with reference to FIGS. 1 and 2. FIG. 1 is a schematic diagram illustrating a configuration of a liquid crystal display, and FIG. 2 is a schematic diagram illustrating a configuration of a plastic film substrate of a second substrate.

The liquid crystal display according to the first embodiment is configured by interposing alignment films 12 and 13 and a liquid crystal 14 between a first substrate 10 and a second substrate 11 and adhering the two substrates through a gap retaining member 15 and a sealant 16.

The first substrate 10 is a substrate where a light blocking layer 10b, a coloration layer 10c, and a common electrode layer 10d are formed on the plastic film substrate 10a and an alignment film 12 is formed on a common electrode layer 10d. The second substrate 11 is a substrate where a glass substrate 11a where an active device 17 is formed in advance is adhered on the plastic film substrate 11b.

As illustrated in FIG. 2, inorganic barriers 10e and 10f are formed on two surfaces of the plastic film substrate 10a, and a resin barrier 10g is formed on the inorganic barrier 10e. As illustrated in FIG. 2, inorganic barriers 11c and 11d are formed on two surfaces of the plastic film substrate 11b; the glass substrate 11a is formed through an adhesive 11e on the inorganic barrier 11c; and a resin barrier 11f is formed on the inorganic barrier 11d. In this manner, a barrier film is formed on one surface or two surfaces of at least one of the plastic film substrates.

The active device 17 of the second substrate 11 includes an active layer 17a containing non-metallic elements as a mixture of oxygen (O) and nitrogen (N) having a ratio of N to O (N number density/O number density) from 0 to 2. Since the active device 17 of the second substrate 11 includes the active layer 17a containing non-metallic elements as a mixture of oxygen (O) and nitrogen (N) having a ratio of N to O (N number density/O number density) from 0 to 2 and is transparent with respect to visible light, transmittance of the display is increased, so that a backlight can have lower power consumption. In addition, since the substrate has flexibility, the liquid crystal display is flexible, and performance characteristics are improved.

The active layer 17a is made of a combination of a metallic material (In₂O₃,SnO₂) and an insulating material (Si₃N₄). Although a nitride is used for a metallic material, since the nitride itself is an insulating material, a semiconductor may not be formed through mixture with other insulating materials. Therefore, an oxide which is a metal itself is used as the metallic material. On the contrary, if a nitride is used for an insulating material, a semiconductor produced by mixing the above two materials becomes a mixture of an oxynitride containing oxygen (O) and nitrogen (N). The mixture is expressed by the following formula. The mixture ratios x and y can be determined under the condition that positive and negative atomic values are balanced.

(IN₂³⁺O₃²⁻)ₓ(Sn⁴⁺O₂²⁻)₆₋ₓ(Si₃⁴⁺N₄³⁻)_{y}=In₂ₓSn₆₋ₓSi_{3y}O₁₂₊ₓN_{4y}

If the mixture ratio of the main metallic material In₂O₃ is x and the mixture ratio of the insulating material Si₃N₄ is y, the mixture ratio of the auxiliary metallic material SnO₂ becomes 6−x due to the balance of the atomic numbers. The ratio x:y of the metallic material and the insulating material is determined by band gaps of the materials and a band gap of a semiconductor formed after the mixture. For example, it is preferable that the range of x be x=0 to 6 (typical value of 5) and the range of y be y=0 to 6 (typical value of 3).

Accordingly, the amount ratio of O:N is as follows.

0=12 to 18 (typical value of 17)

N=0 to 24 (typical value of 12)

Therefore, O:N=1:0 to 2. The number density ratio of nitrogen to 1 oxygen, that is, the ratio of nitrogen (N) to oxygen (O) (N number density/O number density) is from 0 to 2.

In the embodiment, even in the case where the active device 17 including active layer 17a containing non-metallic elements as a mixture of oxygen (O) and nitrogen (N) having a ratio of N to O (N number density/O number density) from 0 to 2 is formed at a temperature of 200° C. or less, the performance is equivalent to or higher than performance of the active device 17 using amorphous silicon formed on a glass substrate at 200° C. or more. Therefore, the embodiment is very appropriate for the case where the active device 17 is formed on a plastic substrate of which the heat resistant temperature is lower than that of a glass substrate. In addition, it is possible to easily obtain the active device 17 having a high field effect mobility, so that the active device 17 is very appropriate for a large-screen, high-accuracy display using an organic EL device which is a current-driven device.

In addition, the range from 0 to 2 of the ratio of nitrogen (N) to oxygen (O) (N number density/O number density) is determined based on the band gap and the balance of atomic numbers as described above in “the ratio of nitrogen (N) to oxygen (O) (N number density/O number density) is in a range from 0 to 2”. If the value is zero (there is no nitrogen), the band gap of the active layer 17a is too narrow according to the quantity of oxygen, the active layer has metallic properties, so that the active device 17 is always in the ON state. On the contrary, if the value is more than 2 (oxygen is insufficient and nitrogen is overabundant), the band gap of the active layer is too wide, the active layer has insulative properties, so that the active device 17 is always in the OFF state. In any cases, there are problems in terms of active device characteristics.

In this manner, in the embodiment, the first substrate 10 is a substrate where the light blocking layer 10b, the coloration layer 10c, and the common electrode layer 10d are formed on the plastic film substrate 10a; the second substrate 11 is a substrate where the glass substrate 11a where the active device 17 is formed in advance is adhered on the plastic film substrate 11b; and a barrier film is formed on one surface or two surfaces of at least one of the plastic film substrate 11b. Since the plastic film substrates 10a and 11b are used for the first substrate 10 and the second substrate 11, in comparison with a glass substrate panel in the related art, the liquid crystal display becomes thinner and difficult to be broken.

In addition, the alignment films 12 and 13 are optical alignment control type alignment films. Since a rubbing process is unnecessary, dust due to shaving of the alignment films 12 and 13 is not generated, and electrostatic charges due to abrasion do not occur. In addition, since the optical alignment control is of a non-contact method, the alignment process can be uniformly performed on the entire surface without influence of unevenness of a base film.

In addition, the sealant 16 is a photo-curing sealant. In comparison with a thermosetting sealant in the related art, the curing time can be reduced. In addition, with respect to the sealant 16, since heat is not used for curing, expansion of the plastic film substrates 10a and 11b which are base members can be suppressed, and the size of a to-be-cured apparatus can be small.

In addition, the gap retaining member 15 is a columnar spacer 153. One portion of the columnar spacer is formed to be in contact with the alignment film 12, and the other portion thereof is formed to be in contact with the alignment film 13. With respect to the position of the columnar spacer, the one portion thereof is formed to be positioned in a light blocking layer area of the first substrate (10a) side, and the other portion thereof is formed to be positioned in an active-device blocking area of the second substrate (11b) side. In this manner, the gap retaining member 15 is the columnar spacer 15a which is disposed between the first substrate 10a and the second substrate 11b and formed in the light blocking layer area of the first substrate (10a) side. Since the columnar spacer is formed only in the light blocking layer area of the first substrate 10a, no spacer exists in the opening portion 12a of the alignment film 12, and no disturbance of alignment occurs, so that contrast becomes high.

### Second Embodiment

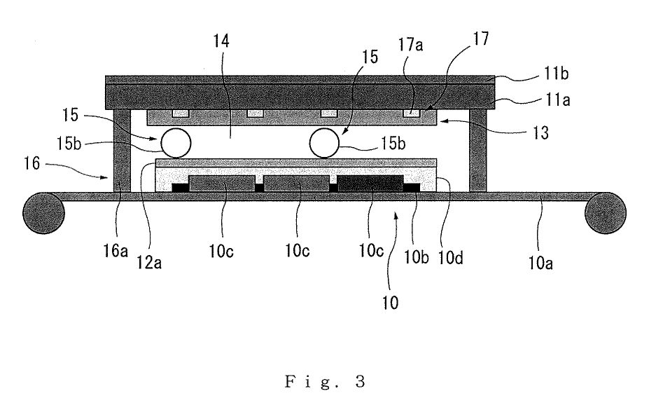

FIG. 3 is a schematic diagram illustrating a configuration of a liquid crystal display according to a second embodiment. In the second embodiment, the same components as those of the first embodiment are denoted by the same reference numerals, and the description thereof will not be made. In the second embodiment, as illustrated in FIG. 3, a spherical spacer 15b is used as the gap retaining member 15. One portion of the spherical spacer 15b is formed to be in contact with the alignment film 12, and the other portion thereof is formed to be in contact with the alignment film 13. With respect to the position of the spherical spacer 15b, the one portion of the spherical spacer 15b is formed to be positioned in a light blocking layer area of the first substrate (10a) side, and the other portion thereof is formed to be positioned in an active-device blocking area of the second substrate (11b) side.

In this manner, the gap retaining member 15 is the spherical spacer 15b which is disposed between the first substrate 10a and the second substrate 11b and is formed in a light blocking layer area of the first substrate (10a) side. Since the spherical spacer 15b is formed only in the light blocking layer area of the first substrate 10a, no spacer exists in the opening portion 12a of the alignment film 12, and no disturbance of alignment occurs, so that contrast becomes high. In addition, since the spherical spacer 15b has larger elastic deformation and smaller plastic deformation than the columnar spacer 15a, the liquid crystal display can smoothly respond to external pressure.

### Third Embodiment

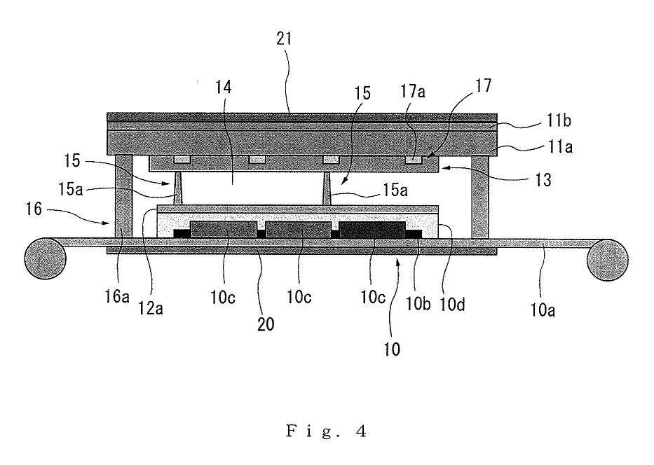

FIG. 4 is a schematic diagram illustrating a configuration of a liquid crystal display according to a third embodiment. In the third embodiment, the same components as those of the first embodiment are denoted by the same reference numerals, and the description thereof will not be made. In the third embodiment, the first substrate 10a and the second substrate 11b have polarizing layers 20 and 21 on the surfaces different from the adhering surfaces, respectively, so that transmission of backlight beams passing through the liquid crystal display can be controlled.

### Fourth Embodiment

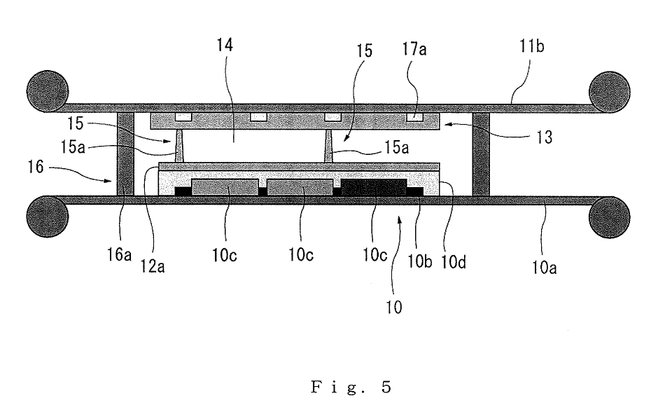

FIG. 5 is a schematic diagram illustrating a configuration of a liquid crystal display according to a fourth embodiment. In the fourth embodiment, the same components as those of the first embodiment are denoted by the same reference numerals, and the description thereof will not be made. In the fourth embodiment, the second substrate 11 is a substrate where the active device 17 is directly formed on the plastic film substrate 11b. Since the active device 17 is directly formed, the liquid crystal display becomes lighter and thinner and difficult to be broken.

### Fifth Embodiment

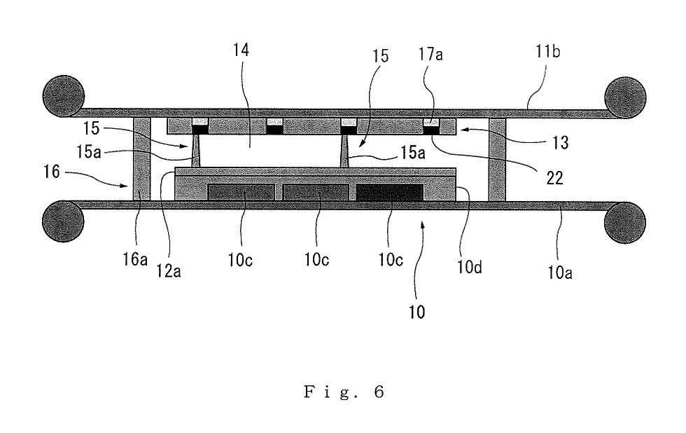

FIG. 6 is a schematic diagram illustrating a configuration of a liquid crystal display according to a fifth embodiment. In the fifth embodiment, the same components as those of the first embodiment are denoted by the same reference numerals, and the description thereof will not be made. In the fifth embodiment, a light blocking layer 22 of the first substrate (10a) side is disposed above the active layer 17a. Therefore, when external light is incident from the viewing direction to the liquid crystal display, the incident light does not hit the active layer 17a, so that malfunction and change in characteristics are difficult to occur in the active layer 17a.

In addition, if the light blocking layer 22 of the first substrate (10a) side is formed just on the active layer 17a, when the external light is incident from the viewing direction to the liquid crystal display, the incident light does not hit the active layer 17a, so that malfunction and change in characteristics in the active layer 17a can be suppressed. In addition, since the light blocking layer 22 is disposed just on the active layer 17a, internal scattered light of the backlight included in the liquid crystal display does not also hit the active layer 17a, so that the change in characteristics are more difficult to occur.

[Method of Manufacturing Liquid Crystal Display and Apparatus for Manufacturing Liquid Crystal Display]

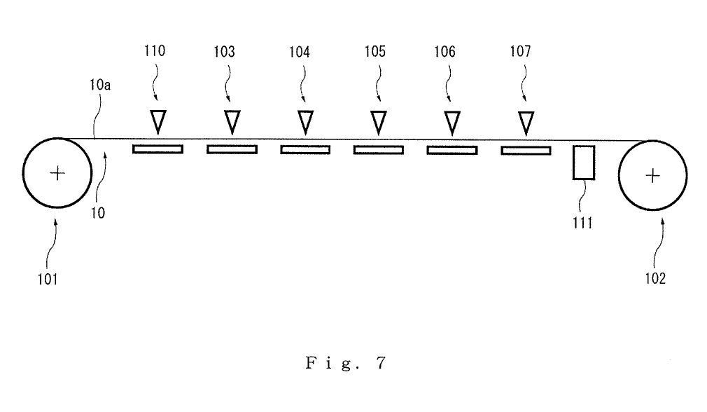

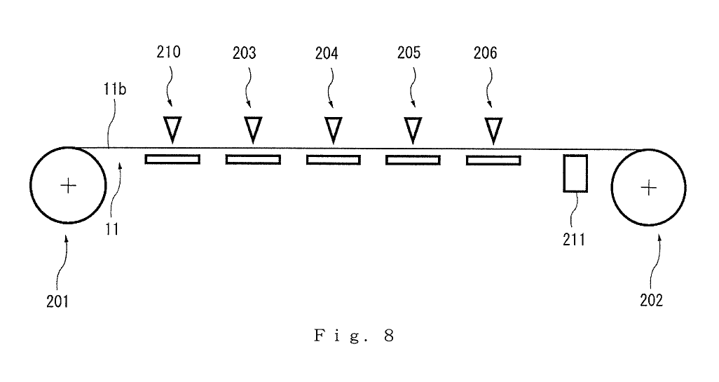

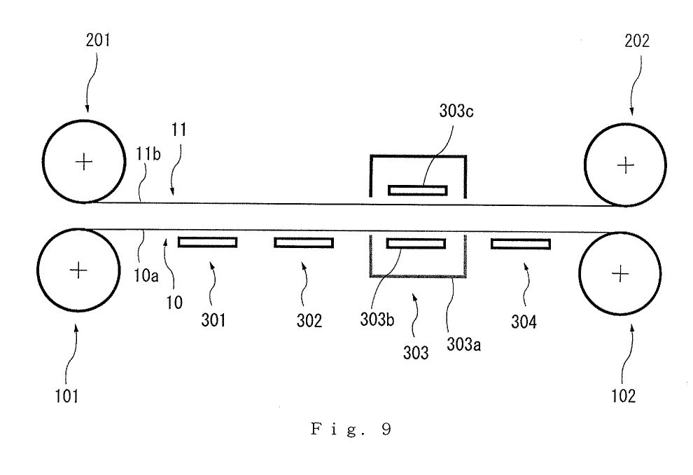

A method of manufacturing a liquid crystal display and an apparatus for manufacturing a liquid crystal display according to the embodiments will be described with reference to FIGS. 7 to 9. FIG. 7 is a schematic diagram illustrating a configuration of an apparatus for manufacturing a first substrate; FIG. 8 is a schematic diagram illustrating a configuration of an apparatus for manufacturing a second substrate; and FIG. 9 is a schematic diagram illustrating a configuration of an apparatus for adhering first and second substrates.

The apparatus for manufacturing a liquid crystal display according to the embodiment includes an apparatus for manufacturing the first substrate illustrated in FIG. 7, an apparatus for manufacturing the second substrate illustrated in FIG. 8, and an apparatus for adhering the first and second substrates illustrated in FIG. 9 to manufacture a liquid crystal display by interposing alignment films and liquid crystal between the first and second substrates and adhering the first and second substrates through a gap retaining member and a sealant.

The apparatus for manufacturing the first substrate illustrated in FIG. 7 includes an extracting portion 101 and a winding portion 102 to extract a roll-shaped plastic film substrate 10a from the extracting portion 101 and wind the roll-shaped plastic film substrate 10a around the winding portion 102. A barrier film formation portion 110 which forms the barrier films on one surface or two surfaces of the plastic film substrate 10a, a light blocking layer formation portion 103 which forms the light blocking layer 10b on the plastic film substrate 10a, a coloration layer formation portion 104 which forms the coloration layer 10c, a common electrode formation portion 105 which forms the common electrode layer 10d, an alignment film formation portion 106 which forms the alignment film 12 on the adhering surface of the first substrate 10, a gap retaining member formation portion 107, and a polarizing layer adhering portion 111 are disposed between the extracting portion 101 and the winding portion 102.

In the gap retaining member formation portion 107, the columnar spacer 15a disposed on the light blocking layer area of the first substrate (10a) side is formed as the gap retaining member 15 by using a photolithography method. Since the columnar spacer 15a can be formed on the light blocking layer area of the first substrate (10a) side at high accuracy by the photolithography method, a line width of the light blocking layer can be reduced, so that transmittance of the display panel is improved.

In addition, in the gap retaining member formation portion 107, the spherical spacer 15b which is disposed between the first substrate 10a and the second substrate 11b and on the light blocking layer area of the first substrate (10a) side is formed as the gap retaining member 15 by using a fixed-point arrangement method. Since the spherical spacer 15b can be formed on the light blocking layer area of the first substrate (10a) side at high accuracy by using the fixed-point arrangement method, a line width of the light blocking layer can be reduced, so that transmittance of the display panel is improved.

In the polarizing layer adhering portion 111, the polarizing layer 20 is formed on the surface different from the adhering surface of the first substrate 10 by using an adhering method. Since the polarizing layer 20 is formed by using the adhering method, a thinner liquid crystal display can be implemented. In addition, the polarizing layer 20 may be formed by using a coating method. Since the polarizing layer is formed by using the coating method, a thinner liquid crystal display can be implemented.

In the embodiment, the plastic film substrate 10a of the first substrate 10 is in a rolled shape. The plastic film substrate 10a can be implemented by a panel process using a roll-to-roll method where the plastic film substrate is extracted from the rolled shape and wound in the rolled shape, and thus, the manufactured display panel can be wound in the rolled shape.

The apparatus for manufacturing the second substrate illustrated in FIG. 8 includes an extracting portion 201 and a winding portion 202 to extract a roll-shaped plastic film substrate 11b from the extracting portion 201 and wind the roll-shaped plastic film substrate 11b around the winding portion 202. A barrier film formation portion 210 which forms the barrier films on one surface or two surfaces of the plastic film substrate 11b, an active device formation portion 203 which fonds the active device 17 on the glass substrate 11a, a glass substrate adhering portion 204 which adheres the glass substrate 11a on the plastic film substrate 11b, a light blocking layer formation portion 205, an alignment film formation portion 206 which forms the alignment film 13 on the adhering surface of the second substrate 11, and a polarizing layer adhering portion 211 are disposed between the extracting portion 201 and the winding portion 202.

In the active device formation portion 203, the second substrate 11 is manufactured by using a method of directly forming the active device 17 on the plastic film substrate 11b. Therefore, the display panel becomes thinner, lighter, and difficult to be broken.

In addition, in the active device 17 of the second substrate 11, an active layer 17a containing non-metallic elements as a mixture of oxygen (O) and nitrogen (N) having a ratio of N to O (N number density/O number density) from 0 to 2 is formed by using a sputtering method.

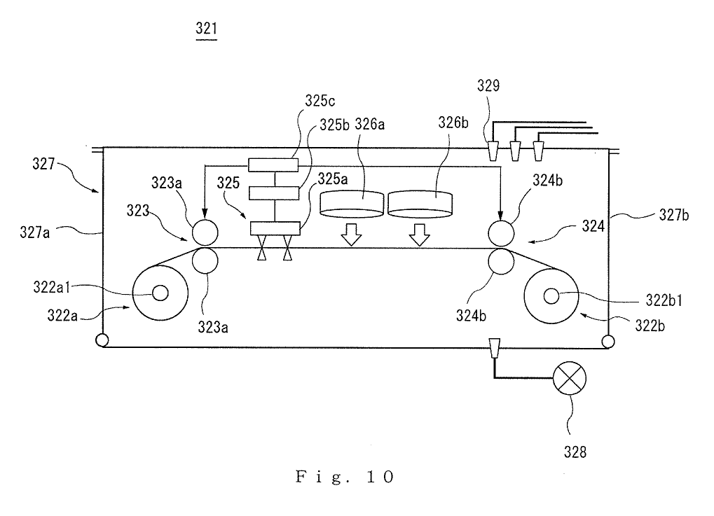

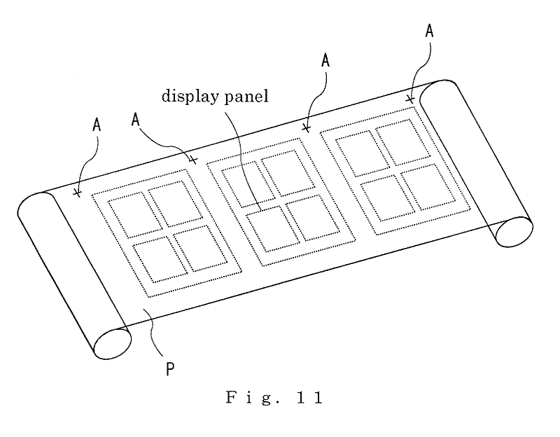

The sputtering method is performed by a sputter apparatus illustrated in FIGS. 10 and 11. The sputter apparatus 321 includes roll-winding mechanisms 322a and 322b, an extracting mechanism 323, a winding mechanism 324, a position-alignment mechanism 325, metal targets 326a and 326b, and a vacuum chamber 327 which accommodates all the mechanism in the inner portion thereof. The vacuum chamber 327 includes opening/closing doors 327a and 327b at the sides of the roll-winding mechanisms 322a and 322b. The opening/closing door 327a is opened and closed so as to set the roll-shaped film substrate P; and the opening/closing door 327b is opened and closed so as to draw out the roll-shaped film substrate P where the active layer 17a is installed.

With respect to the roll-winding mechanism 322a, the roll-shaped film substrate P is mounted around the rotation shaft 322a1, and the rotation shaft 322a1 is rotated by extracting of the roll-shaped film substrate P. With respect to the roll-winding mechanism 322b, the roll-shaped film substrate P is mounted around the rotation shaft 322b1, and the rotation shaft 322b1 is rotated by winding of the roll-shaped film substrate P.

The extracting mechanism 323 includes a pair of extracting rollers 323a. When the pair of the extracting rollers 323a are rotated, the roll-shaped film substrate P is extracted from the one end thereof in the longitudinal direction.

The winding mechanism 324 includes a pair of winding rollers 324b. When the pair of the winding rollers 324b are rotated, the roll-shaped film substrate P is wound from the one end thereof in the longitudinal direction.

The position-alignment mechanism 325 includes a detection sensor 325a, a controller 325b, and a roller driving unit 325c. The detection sensor 325a detects the position-alignment pattern A of the roll-shaped film substrate P illustrated in FIG. 11, and detection information is transmitted to the controller 325b. The controller 325b controls the extracting mechanism 323 and the winding mechanism 324 through the roller driving unit 325c, so that plane position alignment of the roll-shaped film substrate P is performed.

The vacuum chamber 327 is allowed to be in a vacuum state by driving a vacuum pump 328. A gas introduction mechanism 329 is installed in the vacuum chamber 327. The gas introduction mechanism 329 allows an atmosphere gas containing non-metallic elements to be introduced into the vacuum chamber 327.

The metal targets 326a and 326b face a semiconductor forming surface of the roll-shaped film substrate P and are arranged at the positions in a straight line shape along the longitudinal direction of the roll-shaped film substrate P.

The metal target 326a is a target of a metal element, and the metal target 326b is a target of a metalloid element.

With respect to the metal targets 326a and 326b, the sputter apparatus 321 uses a mixture of a plurality of elements containing at least one of non-metallic elements, one of metal elements, and one of metalloid elements as a single target. However, an integrated target of the metal targets 326a and 326b may be used.

In this manner, the sputter apparatus 321 introduces the atmosphere gas containing the non-metallic elements into the vacuum chamber 327 by using the gas introduction mechanism 329. A plurality of metal targets containing metal elements or metalloid elements of the metal targets 326a and 326b or a mixture thereof are disposed in the vacuum chamber 327. If a high voltage is applied to the metal targets 326a and 326b through electrodes, atoms fly out from the surface of the metal target. The atmosphere gas containing the non-metallic elements introduced into the vacuum chamber 327 reacts with the flying-out metal, so that the active layer 17a can be formed on the roll-shaped film substrate P.

The sputter apparatus 321 can form the active layer 17a by a low-temperature process and can implement low process cost. In addition, it is possible to manufacture a liquid crystal display where the active layer 17a having a relatively high field effect mobility can be implemented and the properties are stabilized with respect to light and heat.

In addition, it is possible to manufacture a liquid crystal display where the band gap of the active layer 17a can be freely controlled, and the field effect mobility can be increased.

In addition, the sputter apparatus 321 includes the vacuum chamber 327 which accommodates all the mechanism in the inner portion thereof, extracting from the rolled state and winding to the rolled state are performed during the manufacturing, so that a low-cost process can be implemented.

In addition, the sputter apparatus 321 introduces an atmosphere gas containing non-metallic elements into the vacuum chamber 327 and includes a plurality of metal targets 326a and 326b containing metal elements, metalloid elements, or a mixture thereof. The metal targets 326a and 326b are arranged at the positions in a straight line shape along the longitudinal direction of the roll-shaped film substrate P, so that an active layer 17a having uniform properties can be formed in the roll-shaped film substrate P.

In this manner, the active device 17 of the second substrate 11 including the active layer 17a containing non-metallic elements as a mixture of oxygen (O) and nitrogen (N) having a ratio of N to O (N number density/O number density) from 0 to 2 is formed by using a sputtering method. Since the active device 17 can be formed by using a sputtering method (room temperature) without using a plasma CVD method (300° C.) in the related art, a low-environmental-load, low-temperature process can be implemented.

In the light blocking layer formation portion 205, the light blocking layer 22 of the first substrate (10) side is formed just on the active layer 17a by using a photolithography method. Since the light blocking layer 22 can be formed at high accuracy, a line width of the light blocking layer can be reduced, so that transmittance of the display panel is improved. In this manner, the first substrate 10 and the second substrate 11 are adhered so that the light blocking layer 22 of the first substrate (10) side is disposed above the active layer 17a. Therefore, when external light is incident from the viewing direction to the liquid crystal display, the incident light does not hit the active layer, so that malfunction and change in characteristics are difficult to occur in the active layer.

In the polarizing layer adhering portion 211, the polarizing layer 21 is formed on the surface different from the adhering surface of the second substrate 11 by using an adhering method. Since the polarizing layer 21 is formed by using the adhering method, a thinner liquid crystal display can be implemented. In addition, the polarizing layer 21 may be formed by using a coating method. Since the polarizing layer is formed by using the coating method, a thinner liquid crystal display can be implemented.

In the embodiment, the plastic film substrate 11b of the second substrate 11 is in a rolled shape. The plastic film substrate 11b can be implemented by a panel process using a roll-to-roll method where the plastic film substrate is extracted from the rolled shape and wound in the rolled shape, and thus, the manufactured display panel can be wound in the rolled shape.

In the apparatus for adhering the first and second substrates illustrated in FIG. 9, the first substrate 10 formed by the apparatus for manufacturing the first substrate illustrated in FIG. 7 and the second substrate 11 formed by the apparatus for manufacturing the second substrate illustrated in FIG. 8 are set, and a sealant delineating portion 301 using an ODF process, a liquid crystal charging portion 302, an adhering portion 303 which performs adhering through the delineated sealant, and a curing portion 304 which performs curing the sealant are disposed.

In a manufacturing method using an ODF process, a closed-circle-shaped UV-curing sealant is formed on a transparent substrate without formation of the liquid crystal inlet, and after that, an appropriate amount of liquid crystal is dropped in the inner area of the sealant. After adhering in a vacuum apparatus, the UV-curing sealant is illuminated with UV light, so that the curing is performed. If the ODF process is used, a liquid crystal injection time and a total processing time can be reduced, so that a liquid crystal optical device can be manufactured at low cost.

In the sealant delineating portion 301, sealant delineation is performed on the adhering surface by using the sealant 16. The sealant delineation is performed so that each of outsides of the electrically-operated portions of the liquid crystal display is surrounded. However, the sealant delineation may be performed so that the entire outside of all the electrically-operated portions of the liquid crystal display is surrounded. The sealant delineation is not limited to the sealant delineation surrounding each of the outsides, but the sealant delineation may be performed so that some of the outsides are surrounded. In the embodiment, a liquid-state sealant inserted in a syringe may be coated by using a dispenser so that the sealant is ejected from an opening of the dispenser. By using the fact that the variation in the ejection amount of the opening at each position in the width direction of the opening column is small, the dispenser pushes the liquid-state sealant inserted in the syringe to perform the coating, so that the sealant can be simply and securely applied. As a sealant forming sealant delineation, there are a UV-curing resin, a thermoset resin, an adhesive, and the like, so that gap and in-plane shift are prevented and leakage of liquid crystal is prevented.

In the liquid crystal charging portion 302, a closed-circle-shaped UV-curing sealant 16 is formed on the substrate without formation of the liquid crystal inlet, and after that, an appropriate amount of liquid crystal 15 is dropped in the inner area of the sealant 16. The sealant 16 used for the adhering is provided to the first substrate 10, and liquid crystal 14 is dropped on the first substrate 10 in the sealed portion surrounded by the sealant 16. In the embodiment, the liquid crystal 15 is provided, so that the liquid crystal display is manufactured.

The adhering portion 303 includes a vacuum chamber 303a, a planar stage 303b, and an adhering mechanism 303c. The vacuum chamber 303a is closed to be in a vacuum state during the adhering period. During the transporting period, the vacuum chamber is separated to transport the substrate. The planar stage 303b and the adhering mechanism 303c are disposed within the vacuum chamber 303a. The planar stage 303b maintains the substrate to be in a planar state. The adhering mechanism 303c performs adhering the first substrate 10 and the second substrate 11 on the planar stage 303b.

In the curing portion 304, the sealant 16 is a UV-curing resin, and the sealant 16 is illuminated with UV light, so that the UV-curing resin is cured. Therefore, the curing can be simply and securely performed without deformation due to heat applied to the substrate.

The present invention can be particularly applied to a liquid crystal display using a plastic film substrate, a method of manufacturing a liquid crystal display, and an apparatus for manufacturing a liquid crystal display, a decrease in contrast due to external light reflection can be prevented, and a small-size, thin apparatus can be implemented.

1. A liquid crystal display configured by interposing alignment films and liquid crystal between first and second substrates and adhering the first and second substrates through a gap retaining member and a sealant,
wherein the first substrate is a substrate where a light blocking layer, a coloration layer, and a common electrode layer are formed on a plastic film substrate,
wherein the second substrate is a substrate where a glass substrate where an active device is formed in advance is adhered on a plastic film substrate, and
wherein a barrier film is formed on one surface or two surfaces of at least one of the plastic film substrates.

2. The liquid crystal display according to claim 1, wherein the alignment film is an optical alignment control type alignment film.

3. The liquid crystal display according to claim 1, wherein the sealant is photo-curing sealant.

4. The liquid crystal display according to claim 1, wherein the gap retaining member is a columnar spacer which is formed in a light blocking layer area of the first substrate side.

5. The liquid crystal display according to claim 1, wherein the gap retaining member is a spherical spacer which is disposed between the first and second substrates and which is disposed in a light blocking layer area of the first substrate side.

6. The liquid crystal display according to claim 1, wherein the first and second substrates have polarizing layers on surfaces that are different from an adhering surface.

7. The liquid crystal display according to claim 1, wherein the second substrate is a substrate where active devices are directly formed on the plastic film substrate.

8. The liquid crystal display according to claim 1, wherein the active device of the second substrate has an active layer containing non-metallic elements as a mixture of oxygen (O) and nitrogen (N) having a ratio of N to O (N number density/O number density) from 0 to 2.

9. The liquid crystal display according to claim 1, wherein the light blocking layer of the first substrate side is disposed above the active layer.

10. The liquid crystal display according to claim 9, wherein the light blocking layer of the first substrate side is formed just on the active layer.

11. A method of manufacturing a liquid crystal display configured by interposing alignment films and liquid crystal between first and second substrates and adhering the first and second substrates through a gap retaining member and a sealant, comprising:
forming the first substrate by forming a light blocking layer on a plastic film substrate, forming a coloration layer, and forming a common electrode layer;
forming the second substrate by forming an active device on a glass substrate and adhering the glass substrate to the plastic film substrate;
forming a barrier film on one surface or two surfaces of at least one of the plastic film substrates;
forming alignment films on the adhering surfaces of the first and second substrates, respectively; and
performing sealant delineation using an ODF process, charging liquid crystal, adhering through the delineated sealant, and curing the sealant.

12. The method of manufacturing a liquid crystal display according to claim 11, wherein at least one of the plastic film substrate of the first substrate and the plastic film substrate of the second substrate has a rolled shape.

13. The method of manufacturing a liquid crystal display according to claim 11, wherein a columnar spacer which is disposed on a light blocking layer area of the first substrate side is formed as the gap retaining member by using a photolithography method.

14. The method of manufacturing a liquid crystal display according to claim 11, wherein a spherical spacer which is disposed between the first and second substrates and on a light blocking layer area of the first substrate side is formed as the gap retaining member by using a fixed-point arrangement method.

15. The method of manufacturing a liquid crystal display according to claim 11, wherein a polarizing layer is formed on a surface different from adhering surfaces of the first and second substrates by using an adhering method.

16. The method of manufacturing a liquid crystal display according to claim 11, wherein a polarizing layer is formed on a surface different from adhering surfaces of the first and second substrates by using a coating method.

17. The method of manufacturing a liquid crystal display according to claim 11, wherein the second substrate is manufactured by using a method of directly forming the active device on the plastic film substrate.

18. The method of manufacturing a liquid crystal display according to claim 11, wherein, in the active device of the second substrate, an active layer containing non-metallic elements as a mixture of oxygen (O) and nitrogen (N) having a ratio of N to O (N number density/O number density) from 0 to 2 is formed by a sputtering method.

19. The method of manufacturing a liquid crystal display according to claim 18, wherein the first and second substrates are adhered so that a light blocking layer of the first substrate side is disposed above the active layer.

20. The method of manufacturing a liquid crystal display according to claim 18, wherein a light blocking layer of the first substrate side is formed just on the active layer by using a photolithography method.

21. An apparatus for manufacturing a liquid crystal display by performing the method of manufacturing a liquid crystal display according to claim 11.
